(19) United States
(12) Patent Application Publication
(10) Pub. No.: US 2009/0006436 A1
(43) Pub. Date: Jan. 1, 2009

(54) Automated yield analysis system

(76) Inventors: Yazan A. Alqudah, Portland, OR (US); Hazem Hajj, Portland, OR (US); Mohamed Abdelmoneum, Hillsboro, OR (US); Jan M. Neirynck, Beaverton, OR (US)

Correspondence Address: INTEL CORPORATION;c/o INTELLEVATE, LLC, P.O. BOX 52050, MINNEAPOLIS, MN, 55402, US

(21) Appl. No.: 11/824,436

(22) Filed: Jun. 29, 2007

(51) Int. Cl. G06F 17/30; G06F 12/00

(52) U.S. Cl. 707/101; 707/204; 707/E17.01; 707/E17.005

(57) ABSTRACT

Systems and methods associated with automated semiconductor fabrication device yield analysis are described. One embodiment includes a computing system that includes a working file storage system that stores files corresponding to semiconductor fabrication test devices. The working file storage system may include working directories and executable flows corresponding to working directories. The computing system also includes a data controller that may select a working directory, transfer an input file to the selected working directory, and execute a flow to process an input file and to produce an output file. The output file may include a yield analysis based on data provided by a semiconductor fabrication test device.

### TECHNICAL FIELD

Example systems and methods relate to the field of semiconductor fabrication yield analysis. More specifically, example systems and methods concern automating yield analysis for fabrication devices.

### BACKGROUND

The semiconductor manufacturing industry is competitive. Manufacturing products efficiently may reduce costs and increase competitiveness. Conducting yield analysis based on semiconductor fabrication test device data may increase manufacturing efficiency. For example, conducting effective yield analysis may result in the identification and correction of unexpected trends and excursions in manufacturing processes. Conventionally, engineers and analysts have manually performed end-of-line yield analysis producing inconsistent results in a time consuming manner.

Conventionally, a data file corresponding to a semiconductor fabrication device may have been generated as the device performed a fabrication action. The file may have contained data relating to the operation of the device. This file may have been examined by an engineer to identify defects. Alternatively, an analysis tool may have been manually operated to perform yield analysis on an input file. For example, an analysis tool may have been manually operated a first time to perform yield analysis on an input file containing data relating to the operation of a deposition device and a second time to perform yield analysis based on an input file containing data relating to the operation of an etching device. Manually operating a yield analysis tool may have been inefficient. Additionally, large amounts of data produced by devices may have been difficult to manage manually.

### BRIEF DESCRIPTION OF THE DRAWINGS

The accompanying drawings, which are incorporated in and constitute a part of the specification, illustrate various example system and method embodiments of various aspects of the invention. It will be appreciated that the illustrated element boundaries (e.g., boxes, groups of boxes, or other shapes) in the figures represent one example of the boundaries. One of ordinary skill in the art will appreciate that in some embodiments one element may be designed as multiple elements, multiple elements may be designed as one element, an element shown as an internal component of another element may be implemented as an external component and vice versa, and so on.

FIG. 1 illustrates an example automated semiconductor fabrication yield analysis system.

FIG. 2 illustrates an example automated semiconductor fabrication yield analysis system including working directories paired with flows.

FIG. 3 illustrates an example automated semiconductor fabrication yield analysis system including multiple engines employed in yield analysis.

FIG. 4 illustrates a method for automatic yield analysis.

### DETAILED DESCRIPTION

Example systems and methods facilitate automating semiconductor fabrication yield analysis. Automated yield analysis may be performed in real time by example systems and methods to handle data from different test devices. The data may be stored in large files to which intelligent sampling may be applied. Automating semiconductor fabrication yield analysis may be facilitated by pairing a testing device with a flow containing a series of executable yield analysis engines. Example systems and methods may employ a universal controller for executing a series of engines based on test device files selected for analysis. For example, a universal controller may execute a first series of engines to perform a yield analysis on data provided by a deposition test device and then may execute a second series of engines to perform a yield analysis on data provided by an etching test device. Using a single universal controller to execute a yield analysis for different devices may improve yield analysis efficiency, effectiveness, and consistency.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation.

“Logic”, as used herein, includes but is not limited to hardware, firmware, software in execution and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combinations of gates, other circuit components, and so on.

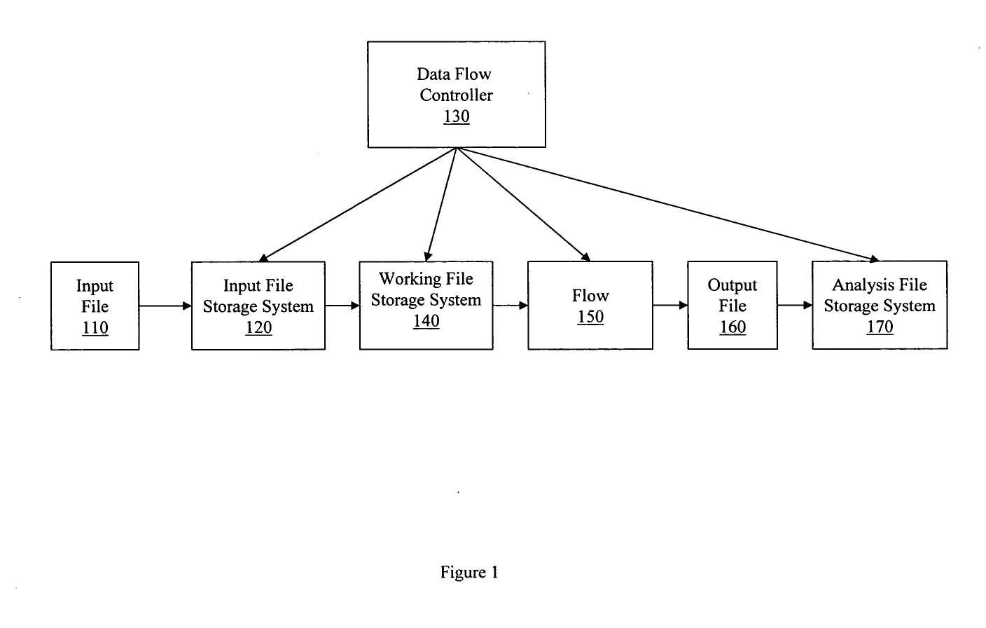

FIG. 1 illustrates elements of an example automated semiconductor fabrication yield analysis system. Input file 110 may contain data provided by a semiconductor fabrication device and/or test device. For example, input file 110 may contain a summary of defects produced by a deposition device. Input file 110 may be generated manually. In another example, a device may generate input file 110 automatically. Input file 110 may be transferred, either manually or automatically, to input file storage system 120 for temporary storage. Input file 110 may be, for example, a test file, which may be a raw data file storing raster-based and/or bit-based information. Input file 110 may be received from a tester located at the end of a fabrication line or at an earlier location in a fabrication line.

Data flow controller 130 may monitor input file storage system 120. When data flow controller 130 detects the presence of input file 110, data flow controller 130 may selectively transfer input file 110 from input file storage system 120 to working file storage system 140. Data flow controller 130 may then cause flow 150 to execute. Flow 150 may be a group of logics that generate a yield analysis. For example, flow 150 may include a first logic to format input data, a second logic to perform a mathematical calculation on the formatted input data, and a third logic to generate a summary of the mathematical calculations performed. Flow 150 may generate a yield analysis based, at least in part, on data contained in input file 110. Yield analysis may include comparing actual device output to expected device output and/or comparing an actual number of defects to an expected number of defects. Flow 150 may produce an output file 160 containing yield analysis data. Data flow controller 130 may transfer output file 160 to analysis file storage system 170 for access by users.

To facilitate yield analysis automation for devices, a working file storage system 140 may contain working directories. The working directories may be associated with test devices. The working directories may also be paired with flows for generating a yield analysis. Some analysis engines may have dependencies. For example, the output of a first analysis engine may be the input of a second analysis engine. Thus, data flow controller 130 may selectively transfer files and invoke engines based on determining that a dependency has been satisfied. The working directory to which input file 110 is to be transferred may be selected based, at least in part, on information contained in input file 110. Thus, once input file 110 is transferred to a working directory, the associated flow may be executed automatically.

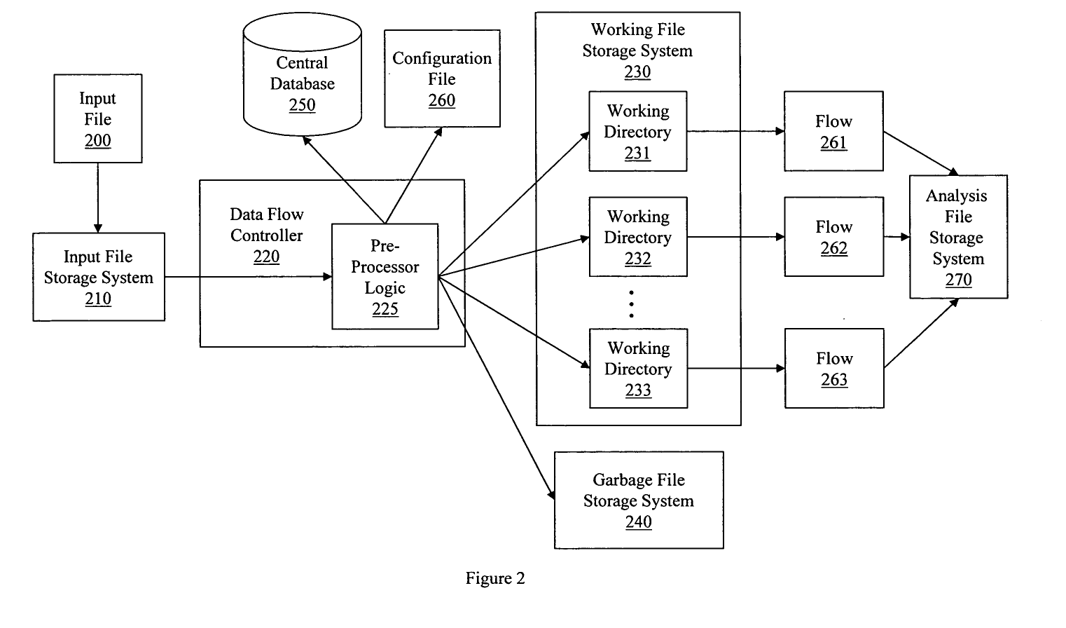

FIG. 2 illustrates an example automated semiconductor fabrication yield analysis system that includes working directories paired with flows. The working directories may be associated with semiconductor fabrication devices and/or semiconductor fabrication test devices. Input file 200 may be generated based on the operation of a device (e.g., tester). Input file 200 may be transferred to input file storage system 210 for temporary storage before it is transferred again to a working directory for analysis. Transfer may depend on determining that a dependency has been satisfied. Data flow controller 220 may monitor input file storage system 210 for the presence of input file 200. After data controller 220 detects input file 200, data flow controller 220 may selectively transfer input file 200 to a working directory in working file storage system 230 based, for example, on a flow sequence. Data controller 210 may execute pre-processor logic 225 to select a working directory to which input file 200 is to be transferred.

In one example, input file 200 may contain a signature identifying a device with which it is associated. Pre-processor logic 225 may extract a signature from input file 200 to determine, in conjunction with central database 250 and configuration file 260, to which working directory to transfer input file 200. For example, input file 200 may contain a lot identification (ID), an operation ID, and a device ID. Central database 250 may contain process information relating to different lots. For example, one process may be a die preparation process in which a wafer is prepared for packaging and testing. A lot may refer to an output produced by a device during particular range of time. Configuration file 260 may contain working directory information associated with a process, operation and device. Pre-processor logic 225 may query central database 250 with a lot ID to obtain process information. Pre-processor logic 225 may use process information, operation ID, and device ID to obtain a working directory destination from configuration file 260.

After pre-processor logic 225 selects a working directory, data flow controller 220 may transfer input file 200 to the selected working directory for processing. The processing may include, for example, determining whether a work material has a defect. Data controller 220 may execute a flow associated with the selected working directory to process input file 200 and to generate an output file containing a yield analysis. The yield analysis may indicate a type and/or number of defects detected. Thus, yield analysis automation may be facilitated. For example, consider three different input files generated from three different test devices. Data flow controller 220 may transfer a first input file to working directory 231, a second input file to working directory 232, and third input file to working directory 233. Data flow controller 220 may cause flow 261 to process the first input file, flow 262 to process the second input file, and flow 263 to process the third input file.

Flows 261, 262, and 263 may generate a yield analysis using the first input file, the second input file, and the third input file respectively. Data controller 220 may transfer output files generated by flows 261, 262, and 263 to analysis file storage system 270. Thus, the need to manually operate an analysis tool on the three input files individually may be eliminated. Therefore, efficiency in semiconductor fabrication yield analysis may be improved. Additionally, the output files may be manipulated to indicate that a predetermined limit of defects has been reached. In this case, a file may replace raw defect data with a limit-exceeded identifier. This facilitates handling large tester files more efficiently since a set of defects may be handled collectively by logically removing a unit under test from consideration.

In certain circumstances, a working directory may not be identifiable in configuration file 260 based on a lot ID, an operation ID, and a device ID extracted from input file 200. If pre-processor logic 225 is not able to identify a working directory for input file 200, data controller 220 may transfer input file 200 to garbage file storage system 240.

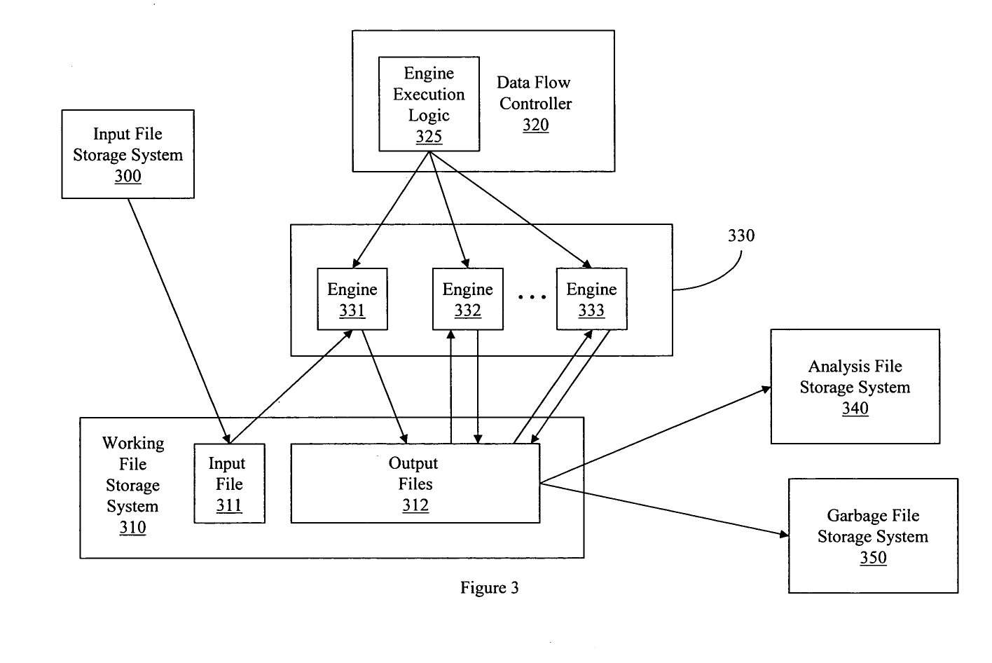

FIG. 3 illustrates an example automated semiconductor fabrication yield analysis system that may include multiple engines for performing yield analysis. An engine may be an executable logic that performs a function relating to yield analysis. For example, an engine may format a file, process a file, and produce a unique output file. An engine may require a unique input file to execute. Assigning unique naming conventions for input and output files may facilitate automation and sequencing. For example, a first engine may require an input file to be named input1.txt and may generate an output file named output1.txt. A second engine may require an input file to be named output1.txt and produce an output file named output2.txt.

Input file 311 may be generated based on the operation of a semiconductor fabrication device. Input file 311 may be transferred to input file storage system 300 for temporary storage. Input file 311 may be transferred from input file storage system 300 to working file storage system 310 for analysis. After input file 311 is transferred from input file storage system 300 to working file storage system 310, data flow controller 320 may execute flow 330 to perform yield analysis based on data in input file 311. Flow 330 may include multiple engines to perform yield analysis. Different engines may perform different yield analysis functions. In one example, the multiple engines may be executed in series. For example, a first engine 331 may format input file 311. Next, a second engine 332 may perform a mathematical operation on input file 311. Finally, a third engine 333 may generate a summary report of input file 311 to be viewed by a user.

In another example, engines of flow 330 may produce output files 312 that may be used as input files by flow 330. For example, a first engine 331 may format input file 311 and produce a first output file. A second engine 332 may perform a mathematical calculation on the first output file and produce a second output file. A third engine 333 may generate a summary report of the second output file and produce a third output file.

Using different engines for performing different yield analysis functions may improve configurability of flow 330. For example, an engine may be added to flow 330, removed from flow 330, or replaced in flow 330 with a new engine. This facilitates configuring flow 330 to operate with different devices.

Data flow controller 320 may use engine execution logic 325 to manage the execution of engines. For example, engine execution logic 325 may execute first engine 331 and wait for a response from first engine 331. After engine execution logic 325 receives notification from first engine 331 that execution completed successfully, engine execution logic 325 may execute second engine 332. After engine execution logic 325 receives notification from second engine 332 that execution completed successfully, engine execution logic 325 may execute third engine 333. After engine execution logic 325 receives notification from third engine 333 that execution completed successfully, engine execution logic 325 may return control to data flow controller 320 along with notification that the engines executed successfully. Therefore, execution of different engines to perform yield analysis may be automated. This may eliminate the need to manually execute engines and thus may facilitate efficient yield analysis with consistent results produced in a timely fashion.

In certain circumstances, an engine may not execute successfully but may still generate a file. This file may be corrupt or inaccurate. Additionally, the presence of the file may interrupt the normal operation of an automated yield analysis system. If engine execution logic 325 receives a notification from an engine that execution was not completed successfully, engine execution logic 325 may terminate execution of remaining engines in a flow. Engine execution logic 325 may return control to data flow controller 320 along with notification that flow 330 did not execute successfully.

If data flow controller 320 receives control along with notification that flow 330 executed successfully, data flow controller 320 may transfer output files 312 to analysis file storage system 340 to be viewed by a user. If data flow controller 320 receives control along with notification that flow 330 did not execute successfully, data flow controller 320 may transfer output files 312 to garbage file storage system 350 for deletion and/or for further analysis. Therefore, corrupted or inaccurate output files may be prevented from being presented to the user. Additionally, uninterrupted operation of an automated yield analysis system may be facilitated.

Engines may perform a variety of functions associated with semiconductor fabrication yield analysis. One example engine may be an RCReader engine that converts a raw data file into a spreadsheet. A raw data file may be a text file or a bit-based defect map. An RCReader engine may generate two files by populating the two files with data from a raw data file. A first file may be a file with all defects and with no test mode classification (ALN). A second file may be a test mode file with no classification (TMN). An RCReader may rotate wafer coordinates and subtract leakage currents before storing data in spreadsheets.

Another example engine may be a test mode (TMC) engine that operates on ALN and TMN files. A TMC engine may use current information to add circuit failure classification. Another example engine may be a wafer map engine that uses defect location information in an ALN file to generate a wafer map. Another example engine may be a bitmap engine that converts defect locations from a logical representation in an ALN file to a physical location. Another example engine may be a summary engine that uses an output of a TMC engine to generate a summary of defects per die and i/o on wafers. Another example engine may be a database engine that loads data, analyses, and/or summaries into a database. While several engines for performing several actions are described, it is to be appreciated that a greater and/or lesser number of engines to perform different actions may be employed.

In certain circumstances, an input file may be large. Processing a large input file may be difficult to manage. To facilitate processing large input files, an RCReader may perform smart sampling on an input file. An RCReader may remove raster units, or building blocks of a die, that exceed a set limit. An RCReader may replace the removed raster units with a new defect that indicates a raster unit has been removed. An RCReader may also logically remove dies that exceed a set limit. An RCReader may replace error data associated with the removed dies with a different defect indicator that indicates a die has been removed. An ALN file generated by an RCReader may contain all defects. In contrast, a TMN file generated by an RCReader may contain only defects that contain current sweeps. Because only a small number of defects may contain currents, removing current information from an ALN file may save space by eliminating the need to add columns for defects that do not contain currents. Thus, efficiency in storing and processing a large input file may be improved. To facilitate the merger of defect information, a unique identification may be assigned to defects on a wafer. Additionally, an output file may contain a header that contains constant data for a wafer. Therefore, an ALN and a TMN file may be merged if needed.

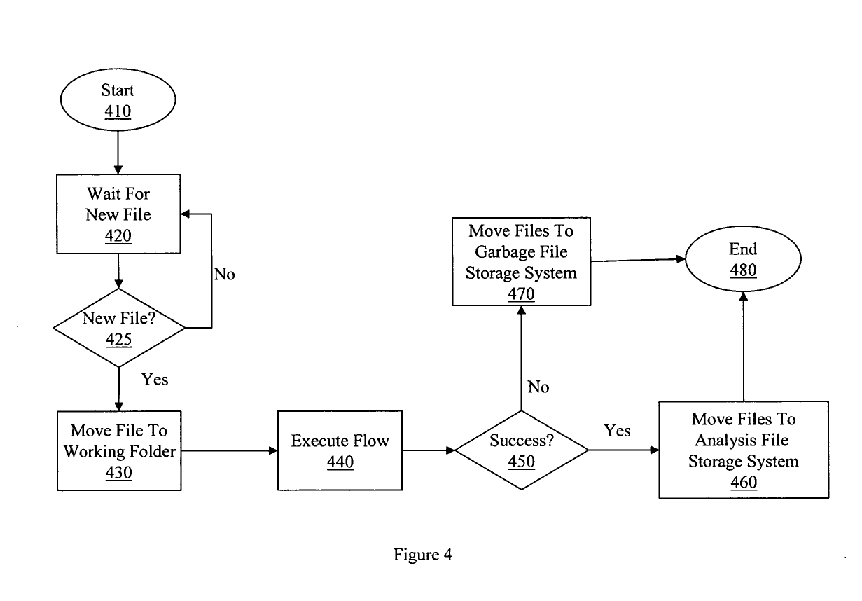

FIG. 4 illustrates a process to automatically perform yield analysis. The process may begin at 410 and then wait for a new file at 420. Once a new file is detected at 425, the file may be moved to a working folder at 430. A flow may then be executed at 440. The flow may be associated with one of the engines described above. Whether the flow executes successfully is identified at 450. If the flow executes successfully, then files may be moved at 460 to an analysis file storage system. If the flow does not execute successfully, then files may be moved at 470 to a garbage file storage system.

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A system, comprising:
a working file storage system comprising one or more working directories corresponding to one or more semiconductor fabrication test devices;
one or more flows corresponding to one or more working directories; and
a data flow controller to:
select a working directory from the one or more working directories;
transfer an input file to the selected working directory, the input file including test data from a semiconductor fabrication testing device; and
cause a flow corresponding to the selected working directory to produce an output file storing a yield analysis data.

2. The system of claim 1, where the input file stores defect information in one or more of, a raster-based format, and a text-based format.

3. The system of claim 1, a flow comprising one or more engines, an engine being an executable logic for performing a yield analysis function.

4. The system of claim 3, the one or more engines being executed in series.

5. The system of claim 4, where an engine is to perform one or more of:
formatting an input file;
using current information to add circuit failure classification to test device data in an input file;
generating a wafer map using defect location information;
converting defect locations in a test device data from a logical representation to a physical location;
loading data into a database; and
smart sampling an input file.

6. The system of claim 5, where smart sampling an input file comprises:
logically replacing individual block defect data points associated with defects in a building block with a collective block replacement indicator upon determining that a number of defects associated with the building block exceeds a block limit;
logically replacing individual die block defect data points associated with defects in a die upon determining that a number of defects associated with the die exceeds a die limit; and
generating a defects file including one or more of, an individual block defect data point, a collective block replacement indicator, an individual die defect data point, and a collective die replacement indicator.

7. The system of claim 1, the data flow controller comprising a pre-processor logic to select the working directory from the one or more working directories based, at least in part, on data obtained from the input file.

8. The system of claim 7, the data obtained from the input file including a file signature relating the file to one or more of, a semiconductor fabrication lot, a semiconductor fabrication device, and a semiconductor fabrication operation.

9. The system of claim 1, the data flow controller comprising an engine execution logic to:
execute an engine; and
receive a response from the engine, the response to indicate the outcome of the engine execution.

10. The system of claim 9, comprising an analysis file storage system to store an output file.

11. The system of claim 10, the data flow controller to selectively transfer an output file from the selected working directory to the analysis file storage system upon determining that the engine executed successfully.

12. The system of claim 9, comprising a garbage file storage system to store an output file.

13. The system of claim 12, the data flow controller to selectively transfer an output file from the selected working directory to the garbage file storage system upon determining that the engine did not execute successfully.

14. A system, comprising
a working file storage system comprising one or more working directories corresponding to one or more semiconductor fabrication test devices;
one or more flows corresponding to the one or more working directories, the one or more flows comprising one or more engines, an engine being an executable logic for performing a yield analysis function, the one or more engines to be executed in series;
a data flow controller comprising:
a pre-processor logic to:
select the working directory based, at least in part, on data obtained from the input file, the data including a file signature related to one or more of, a semiconductor fabrication lot, a semiconductor fabrication device, and a semiconductor fabrication operation; and
an engine execution logic to:
execute an engine; and
receive a response from the engine, the response to indicate the outcome of the engine execution; and
where the data flow controller selectively transfers an input file to the selected working directory; and
an analysis file storage system to store an output file, the data flow controller to selectively transfer an output file from the selected working directory to the analysis storage system upon determining that the engine executed successfully; and
a garbage file storage system to store an output file, the data flow controller to selectively transfer an output file from the selected working directory to the garbage file storage system upon determining that the engine did not execute successfully;
where yield analysis is performed on data provided by one or more semiconductor fabrication test devices, the yield analysis being performed automatically based, at least in part, on detecting the input file.

15. A method for automatically performing yield analysis, comprising:
waiting for an input file comprising test data associated with a semiconductor fabrication tester;
moving an input file to a working folder upon detecting the presence of an input file related to the working folder;
executing a computerized flow to perform a semiconductor fabrication yield analysis based on data store in the input file;
selectively transferring an output file to a file analysis storage system upon determining that execution was successful; and
selectively transferring an output file to a garbage file storage system upon determining that execution was not successful.
